(19) United States
(12) Patent Application Publication
(10) Pub. No.: US 2003/0146204 A1
(43) Pub. Date: Aug. 7, 2003

(54) Heating element, liquid container and method for detecting temperature changes

(76) Inventor: Simon Kaastra, Dinxperlo (NL)

Correspondence Address: John W McIlvaine, 700 Koppers Building, 436 Seventh Avenue, Pittsburgh, PA, 15219-1818, US

(21) Appl. No.: 10/220,992

(22) PCT Filed: Mar. 7, 2001
(86) PCT No.: PCT/NL01/00190

(51) Int. Cl. F27D 11/00; H05B 1/02

(52) U.S. Cl. 219/441; 392/480; 219/497

(57) ABSTRACT

The invention relates to a heating element with at least one electrical resistance, wherein between a surface for heating and the electrical resistance is situated a dielectric, onto which dielectric connects an ammeter for detecting a leakage current. In addition, the invention comprises a liquid container provided with such a heating element. The invention also relates to a method for detecting a temperature change in a heating element formed by an electrical resistance by measuring a leakage current discharged by a dielectric connected to the heating element.

The invention relates to a heating element formed by an electrical resistance, to a liquid container provided with such a heating element, and to a method for detecting a temperature change in a heating element formed by an electrical resistance.

The heating of heating elements, as applied for instance for heating liquid in liquid containers or heating of hot plates, takes place according to the prior art with for instance electrical resistances which are heated by current feed. Examples hereof are for instance a heating spiral which is placed in the liquid container and an electrically heated grill plate. In order to prevent overheating of the heating element such as can for instance in the case of boiling-dry or accumulated scale, the prior art electrical heating elements are usually provided with a separate temperature sensor such that the current feed of a heating element can be limited when the temperature rises too high. The drawbacks of the existing heating elements are that they are usually situated in the liquid for heating, that there is a relatively great risk of undetected overheating and/or that separate provisions have to be made for temperature monitoring.

The object of the invention is to provide an improved heating element and method with which the above stated drawbacks can be prevented while retaining the advantages of the prior art.

The invention provides for this purpose a heating element formed by an electrical resistance, wherein between a surface for heating and the electrical resistance is situated a dielectric, a leakage current of which can be detected by means of an ammeter. The ammeter can be electrically coupled for this purpose directly to the dielectric, but it is also possible for the ammeter to be electrically coupled to the dielectric via a medium for heating. The surface for heating is herein preferably manufactured from a heat-conducting (and usually also electrically conducting) material, and is mounted in electrically insulated manner, or at least mounted in insulated manner such that a leakage current through the dielectric can only be discharged via the ammeter. The earthing of the heating element likewise runs only via the ammeter, which must be dimensioned for this purpose such that the capacity for current feed is sufficiently great in accordance with the standards applicable thereto (for instance IEC 60335). In the case of an electrically conducting surface for heating it is possible for the ammeter for detecting a leakage current through the dielectric to connect onto the dielectric itself or, when mounted in electrically insulated manner, onto the surface for heating. By means of the dielectric the electrical resistance is electrically insulated relative to the wall of the surface for heating. A leakage current coming from the heating element will flow through the dielectric, which current will depend partly on the resistance of the dielectric. Research has shown that a dielectric can be applied which has a resistance that can depend inter alia on the temperature of the dielectric. If the resistance of the dielectric at varying temperatures is known, a temperature of the dielectric can be determined by detecting the leakage current, at least when the voltage over the heating element remains more or less constant or is at least also known. The leakage current, which can be detected in simple manner with an ammeter, thus forms a measurement value with which the temperature of the dielectric, and therefore the heating element and/or the electrical resistance, can be determined. An additional temperature sensor is therefore unnecessary, while the heating element can be assembled with a surface for heating in very simple manner, preferably such that the heating element is situated on the side remote from the side of the surface for heating to be utilized for heating purposes. When the heating element is assembled with a surface for heating manufactured from an electrically conducting material and this is also electrically insulated relative to outside objects, the leakage current passing through the dielectric can also be measured on the surface for heating or an electrically conducting component connected thereto. In yet another variant the surface for heating makes contact with a liquid for heating, in which case the leakage current can also be measured on this liquid (the liquid will of course form an extra resistance here). Use can also be made of the liquid to earth such a liquid container.

While it is the case that the French patent application FR 2 275 103 describes a heating device constructed from a plurality of functional layers including a dielectric layer, there is however no reference to coupling of an ammeter to this layer for detecting that a determined temperature has been reached. The described heating device comprises an insulating layer, a metal layer, a dielectric layer and a heating element. An insulating gasket is arranged round these layers.

In a preferred embodiment the capacitive current of a power supply of the electrical resistance is shifted through 90° relative to the voltage over the electrical resistance. When with such a power supply the time of measurement is determined at a moment that the leakage current is maximal, the capacitive current part will then be zero. The consequence hereof is that the leakage current measurement can be performed relatively accurately, whereby the temperature of the dielectric can also be determined relatively accurately. The power supply according to the present preferred embodiment therefore increases the accuracy with which the temperature of the dielectric can be determined.

Particularly favourable results are realized with a dielectric manufactured from glass ceramic or kerdi® which contains in total less than 10% by weight of alkali metals such as sodium, potassium and lithium. Glass ceramic or kerdi® containing a total of more than 10% by weight of alkali metals can however also be used if for instance a leakage current detection is desired at temperatures lower than 200° C. A glass ceramic or kerdi® can be applied in relatively advantageous manner to a surface for heating, and can also take a very wear-resistant form. The conductivity of the dielectric can be readily determined by making variations in the alkali content of the glass ceramic or kerdi® and/or by adding determined quantities of one or more of the additives zirconium oxide, zirconium silicate or quartz. The glass ceramic or kerdi® preferably contains a total of 1 to 3% by weight of titanium oxide and zinc oxide, which also makes it suitable for higher power densities. A dielectric can for instance be created by means of these additives which is suitable for higher power densities, and the resistance of which suddenly declines sharply at a determined temperature, such as for instance a temperature around 200-250° C. Overheating (for instance through boiling-dry or excessive deposition of scale) of a heating element can thus be detected in clear manner. In a particular preferred embodiment the heating element can also be provided with a plurality of dielectric layers with mutually differing properties, so that different temperature ranges can be accurately determined. These layers can for instance be applied on two sides in relation to an electrically conducting track to be heated.

A particular preferred embodiment of the heating element comprises a melt resistance, formed for instance by a narrowed portion of smaller cross-section. As the temperature of the heating element rises, this narrowed portion will be the first to bring about an interruption if the power supply is not limited, whereby further current feed, and thus further heating, becomes impossible. The melt resistance therefore forms an additional protection against overheating if a limitation of the power supply does not already take place on the basis of the increasing leakage current through the dielectric. In addition to the embodiment of the melt resistance as narrowed portion, other embodiments can also be envisaged such as a soldered feed with a defined melting point which is lower than the melting point of the remaining part of the electrical resistance. It is also possible to couple the ammeter to a control for the heating element such that when a determined threshold value in the leakage current level is reached the power supply to the heating element is reduced or interrupted. Excessive overheating can be prevented in this manner.

The invention also provides a liquid container provided with a heating element as described above, wherein the liquid container is a through-flow heating element such as for instance a tube or pipe. It is also possible for the liquid container to be embodied as a liquid container such as a kettle in which a still or moving liquid is heated. Electrical heating elements can be applied particularly advantageously in combination with a liquid container.

The invention also provides a method for detecting a temperature change in a heating element formed by an electrical resistance by measuring the leakage current discharged by a dielectric connected to the heating element. The leakage current through the dielectric can herein be measured on an electrically conducting surface for heating which connects onto the dielectric, via an electrically conducting medium for heating or directly on the dielectric. Depending on the conditions in which the method is applied, the most advantageous method of measurement in these specific conditions can be selected. The advantages of applying this method have already been described above with reference to the heating element and the liquid container according to the invention.

The present invention will be further elucidated with reference to the non-limitative embodiments shown in the following figures. Herein:

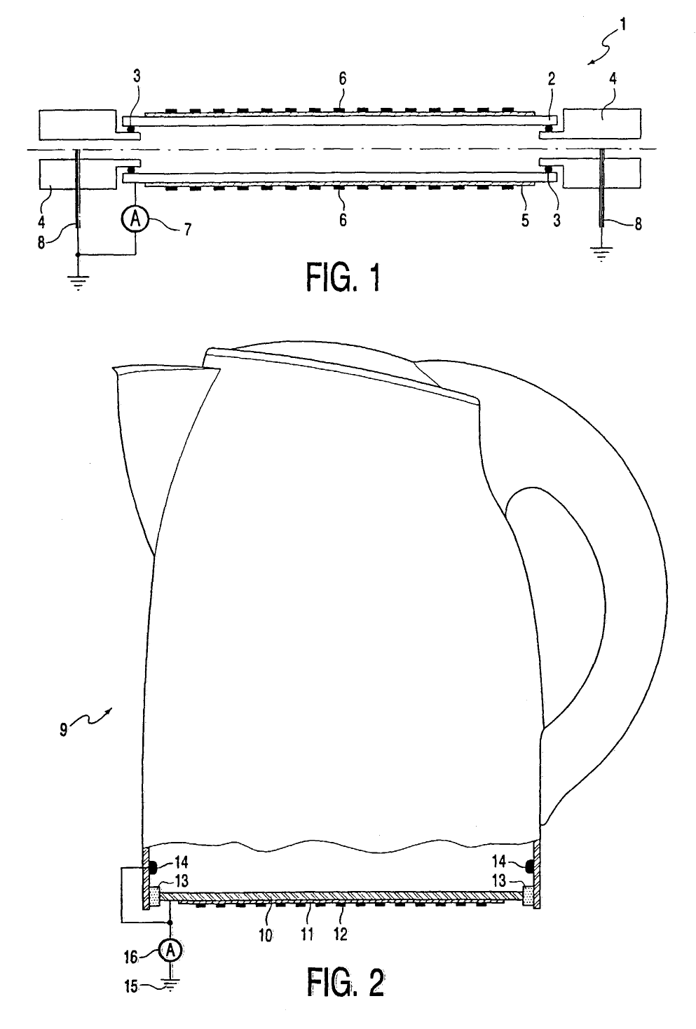

FIG. 1 shows a cross-section through a device according to the invention,

FIG. 2 shows a cross-section through another embodiment of a device according to the invention, and

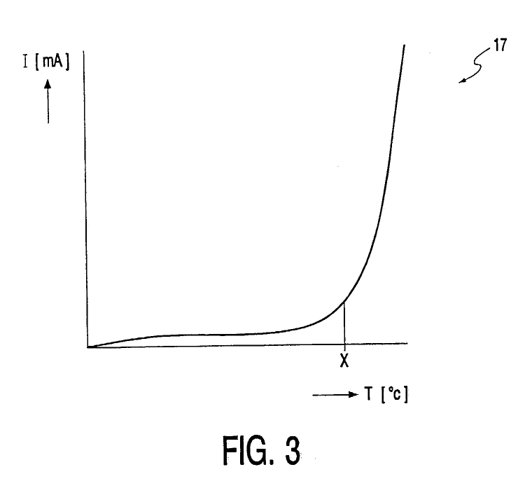

FIG. 3 shows a schematic view of a leakage current curve of a dielectric.

FIG. 1 shows a liquid container 1 of a through-flow type which consists of an electrically conducting, for instance steel tube 2 which is mounted via gaskets 3 in electrically insulated manner between two plastic bushes 4.

To the outer side of tube 2 is applied a dielectric layer 5 which consists of for instance glass ceramic or kerdi® or enamel glass. On the side of the dielectric layer 5 remote from tube 2 is situated an electrically conducting track 6 which forms part of the heating element. By supplying power through the conductive track 6 the dielectric layer 5 and tube 2 will be heated, which heat is subsequently transferred to a liquid in liquid container 1. As already described above, the resistance of dielectric layer 5 will fall sharply when a determined temperature is exceeded. By connecting an earthed ammeter 7 to tube 2 the leakage current coming from the heating element can be measured. When a determined temperature is exceeded, the leakage current will increase sharply due to the decreased resistance of dielectric layer 5, so that this can be detected by ammeter 7. For earthing of liquid in liquid container 1 earthing elements 8 are placed through the plastic bushes 4 such that they can enter into contact with liquid located in liquid container 1. Not shown in this figure is that ammeter 7 can be coupled to a control for the power supply to heating element 6.

FIG. 2 shows a cross-section through a water kettle 9 which is provided with an electrically conducting base plate 10. On the side remote from water kettle 9 the base plate 10 is provided with a dielectric layer 11 on which electrical tracks 12 of a heating element are arranged on the side remote from base plate 10. For an electrically insulated mounting of base plate 10 in water kettle 9 the edges of base plate 10 engage on an electrically insulating gasket 13. This latter can optionally also be omitted, for instance if the housing of water kettle 9 is manufactured from an electrically insulating material. For earthing of the liquid in water kettle 9 there is arranged close to base plate 10 an electrically conducting ring 14 which is coupled via an ammeter 16 to the earth 15. For direct measurement of the leakage current through dielectric layer 11 an ammeter 16, which is earthed, connects onto base plate 10. As an alternative (not shown), it is also possible for an ammeter 16 to connect directly onto the dielectric layer 11, which may be necessary for instance if base plate 10 is manufactured from a non-electrically conducting material. According to yet another alternative, likewise not shown, it is also possible to measure the leakage current only via the electrically conducting ring 14, in which case the leakage current must be conducted through a medium located in water kettle 9. For the operation of water kettle 10 reference is made to the operation of liquid container 1 as described with reference to FIG. 1. By means of ammeter 16 it is for instance possible to detect that water kettle 9 is boiling dry or that a determined quantity of scale has adhered to base plate 10.

Finally, FIG. 3 shows a graph 17 of a leakage current curve wherein the temperature (T) is plotted on a horizontal axis against a leakage current (I) on the vertical axis. It can clearly be seen that the leakage current remains limited up to a point close to a determined temperature (X), above which temperature the leakage current increases very rapidly. The leakage current increase close to the temperature X is a consequence of the sharply falling resistance at this temperature of the dielectric which is being used. The height of temperature X and the shape of graph 17 are determined by the composition of dielectric layer 5, 11. Particularly for application in liquid heating it is possible by means of the described additive substances to obtain a sharp increase in the leakage current in the range 200-250° C.

Although the invention is described on the basis of only a few embodiments, it will be apparent to all that the invention is by no means limited to the described and shown embodiments. The invention can thus also be applied in heating elements which, other than in the shown embodiments, do not consist of an element based on thick-film technique. An example of such another construction is a heating element consisting of an electrical heating wire situated in a tube filled with a dielectric. The dielectric can for instance consist of magnesium oxide. Many other variations are however still possible for the skilled person within the scope of the invention.

1. Heating element with at least one electrical resistance (6,12), characterized in that between a surface (2,10) for heating and the electrical resistance (6,12) is situated a dielectric (5,11), a leakage current of which can be detected by means of an ammeter (7,16).

2. Heating element as claimed in claim 1, wherein the ammeter (7,16) is directly coupled electrically to the dielectric (5,11).

3. Heating element as claimed in claim 1, wherein the ammeter (7,16) is coupled electrically to the dielectric (5,11) via a medium for heating.

4. Heating element as claimed in any of the foregoing claims, wherein the electrical resistance (6,12) is manufactured from an electrically conducting material which is mounted on the dielectric (5,11).

5. Heating element as claimed in claim 4, wherein the ammeter (7,16) for detecting a leakage current through the dielectric (5,11) connects onto the surface (2,10) for heating.

6. Heating element as claimed in any of the foregoing claims, wherein the capacitive current of a power supply of the electrical resistance (6,12) is shifted through 90° relative to the voltage over the electrical resistance (6,12).

7. Heating element as claimed in any of the foregoing claims, wherein the dielectric (5,11) is formed by glass ceramic or kerdi®.

8. Heating element as claimed in claim 7, wherein the glass ceramic or kerdi® contains in total less than 10% by weight of alkali metals such as sodium, potassium and lithium.

9. Heating element as claimed in claim 7 or 8, wherein the glass ceramic or kerdi® contains one or more of the additives zirconium oxide, zirconium silicate or quartz.

10. Heating element as claimed in any of the claims 7-9, wherein the glass ceramic or kerdi® contains a total of 1 to 3% by weight of titanium oxide and zinc oxide.

11. Heating element as claimed in any of the foregoing claims, wherein the electrical resistance (6,12) comprises a melt resistance, formed for instance by a narrowed portion of smaller cross-section.

12. Heating element as claimed in any of the foregoing claims, wherein the ammeter (7,16) is coupled to a control for the heating element.

13. Liquid container (1,9) provided with a heating element as claimed in any of the foregoing claims, wherein the liquid container (1,9) is a through-flow heating element (1).

14. Liquid container (1,9) provided with a heating element as claimed in any of the claims 1-13, wherein the liquid container (1,9) is a kettle (9).

15. Method for detecting a temperature change in a heating element formed by an electrical resistance (6,12) by measuring a leakage current discharged by a dielectric (5,11) connected to the heating element.

16. Method as claimed in claim 15, wherein the leakage current through the dielectric (5,11) is measured on an electrically conducting surface (2,10) for heating connecting onto the dielectric (5,11).

17. Method as claimed in claim 15, wherein the leakage current through the dielectric (5,11 ) is measured via an electrically conducting medium for heating.

18. Method as claimed in claim 15, wherein the leakage current through the dielectric (5,11) is measured on the dielectric (5,11).
